(19) United States
(12) Patent Application Publication
(10) Pub. No.: US 2021/0252835 A1
(43) Pub. Date: Aug. 19, 2021

(54) VEHICLE GLASS WITH INTEGRATED SENSOR CHIP

(71) Applicant: GM GLOBAL TECHNOLOGY OPERATIONS LLC, Detroit, MI (US)

(72) Inventors: Adam L. Wright, Livonia, MI (US); Nathaniel W. Hart, Beverly Hills, MI (US)

(73) Assignee: GM GLOBAL TECHNOLOGY OPERATIONS LLC, Detroit, MI (US)

(21) Appl. No.: 16/793,483

(22) Filed: Feb. 18, 2020

(51) Int. Cl. B32B 17/10

(52) U.S. Cl. CPC B32B 17/10678; B32B 7/12; B32B 2605/006; B32B 17/10376

(57) ABSTRACT

A sensor-integrated glass assembly includes a first glass component including an automotive glass material, a second glass component including an interlayer material, the second glass component exterior to the first glass component, a third glass component including a high transmission glass material, the third glass component exterior to the second glass component such that the second glass component is positioned between the first and third glass components, and a single chip sensor having a sensor lens, the single chip sensor coupled with the second glass component. The single chip sensor is positioned on the interlayer component such that a transmission from the single chip sensor passes through the third glass component and does not pass through the first glass component.

### INTRODUCTION

The present disclosure relates generally to a single chip sensor, such as a single chip LiDAR sensor, integrated into a component, such as a vehicle glass component.

The placement of sensors, such as LiDAR sensors behind vehicle glass components causes a reduction in range and optical quality of the sensor. The use of optical-grade glass that allows improved optical quality and range for sensors mounted behind the component increases the manufacturing cost of the component.

### SUMMARY

Embodiments according to the present disclosure provide a number of advantages. For example, embodiments according to the present disclosure enable the use of smaller quantities of expensive, optical grade glass while increasing the effective range and optical quality of the sensor.

In one aspect of the present disclosure, a sensor-integrated glass assembly includes a first glass including an automotive glass material, a second glass component including an interlayer material, the second glass component exterior to the first glass component, a third glass component including a high transmission glass material, the third glass component exterior to the second glass component such that the second glass component is positioned between the first and third glass components, and a single chip sensor having a sensor lens, the single chip sensor coupled with the second glass component. The single chip sensor is positioned on the second glass component such that a transmission from the single chip sensor passes through the third glass component and does not pass through the first glass component.

In some aspects, the second glass component is a PVB material.

In some aspects, the sensor-integrated glass assembly further includes an intermediate layer applied to an interior facing surface of the third glass component.

In some aspects, the intermediate layer includes an antireflective coating.

In some aspects, the sensor-integrated glass assembly further includes a solar block filtering layer positioned interior of the single chip sensor such that the transmission from the single chip sensor does not pass through the solar block filtering layer.

In some aspects, the glass assembly includes a heat element to defog the sensor lens of the single chip sensor.

In some aspects, the glass assembly includes a heat conductive material to cool the sensor lens of the single chip sensor.

In some aspects, the sensor-integrated glass assembly further includes a heat sink thermally coupled to the single chip sensor.

In some aspects, the sensor-integrated glass assembly further includes a connection member coupled to the single chip sensor and positioned interior of the single chip sensor to provide power and communication to the single chip sensor.

In another aspect of the disclosure, a method for manufacturing a sensor-integrated glass assembly for a vehicle sensor includes providing a single chip sensor including a sensor lens, providing a first glass component, a second glass component, and a third glass component, integrating the single chip sensor with the second glass component, adhering, with an optical clear adhesive, the first glass component to an interior facing surface of the second glass component and adhering the third glass component to an exterior facing surface of the second glass component such that the second glass component is positioned between the first and third glass components and the sensor lens is positioned to transmit and receive optical transmission through the third glass component, applying an antireflective coating to the third glass component, and connecting a connection member to the single chip sensor.

In some aspects, the method further includes curing the sensor-integrated glass assembly in an autoclave process.

In some aspects, the method further includes applying a solar block filtering layer to the first glass component.

In another aspect of the present disclosure, an automotive vehicle includes a vehicle body including a sensor-integrated glass assembly, the sensor-integrated glass assembly including a first glass component including an automotive glass material; a second glass component including an interlayer material, the second glass component exterior to the first glass component; a third glass component including a high transmission glass material, the third glass component exterior to the second glass component such that the second glass component is positioned between the first and third glass components; and a single chip sensor having a sensor lens, the single chip sensor coupled with the second glass component. The single chip sensor is positioned on the second glass component such that a transmission from the single chip sensor passes through the third glass component and does not pass through the first glass component.

In some aspects, the second glass component is a PVB material.

In some aspects, the sensor-integrated glass assembly further includes an intermediate layer applied to an interior facing surface of the third glass component.

In some aspects, the intermediate layer includes an antireflective coating.

In some aspects, the sensor-integrated glass assembly includes a heat element to defog the sensor lens of the single chip sensor.

In some aspects, the sensor-integrated glass assembly includes a heat conductive material to cool the sensor lens of the single chip sensor.

In some aspects, the automotive vehicle further includes a heat sink thermally coupled to the single chip sensor.

In some aspects, the sensor-integrated glass assembly includes a solar block filtering layer positioned interior of the single chip sensor such that the transmission from the single chip sensor does not pass through the solar block filtering layer.

### BRIEF DESCRIPTION OF THE DRAWINGS

The present disclosure will be described in conjunction with the following figures, wherein like numerals denote like elements.

FIG. 1 is a schematic illustration of a vehicle including a sensor-integrated glass component, according to an embodiment of the disclosure.

FIG. 2 is a schematic overhead cut-away view of a sensor-integrated glass component, according to an embodiment of the disclosure.

FIG. 3 is a flow diagram of a method for manufacturing a sensor-integrated glass component, according to an embodiment of the disclosure.

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings. Any dimensions disclosed in the drawings or elsewhere herein are for the purpose of illustration only.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present disclosure. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Certain terminology may be used in the following description for the purpose of reference only, and thus are not intended to be limiting. For example, terms such as “above” and “below” refer to directions in the drawings to which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof, and words of similar import.

Typically, a vehicle sensor, such as a LiDAR sensor, is mounted behind a vehicle glass component with multiple layers of expensive optical-grade glass used to cover the lens portion of the sensor. This approach increases the cost and manufacturing complexity of the glass component and also sacrifice the range and optical quality of the sensor.

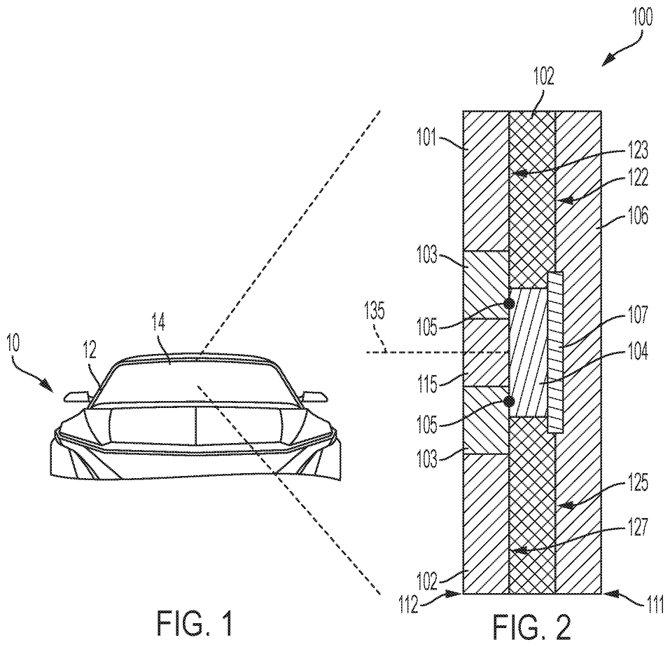

FIG. 1 schematically illustrates a vehicle 10. The vehicle 10 includes a body 12. The body 12 includes a plurality of body structures and components, such as a windshield 14, that form an exterior surface of the vehicle 10. In various embodiments, the body 12 includes one or more sensor-integrated glass assemblies 100, for example and without limitation. The sensor-integrated glass assembly 100 includes, in various embodiments, a single chip sensor integrated with the glass assembly to reduce the use of expensive, optical grade materials and improve optical quality of the sensor-integrated glass assembly.

As shown in FIG. 1, the sensor-integrated glass assembly 100 integrates a single chip sensor, such as a chip scale LiDAR sensor, into a vehicle glass component, such as the windshield 14. In other embodiments, the sensor-integrated glass assembly 100 is used for other glass components of the vehicle, such as a rear windshield, side windows, etc., for example and without limitation. As is known, the single chip sensor is a chip scale LiDAR sensor that offers significant space, weight, and cost reductions over a separate sensor lens assembly coupled with a sensor module. The single chip sensor is integrated directly in an automotive glass material. The single chip sensor is mounted closer to the exterior or A-surface of the glass component to maintain a wide field of view and sensor performance in application. Furthermore, the method of manufacture discussed herein is scalable to other vehicle components incorporating LiDAR sensors or other optical sensors, such as the rear windshield, side windows, etc. Integration of the sensor into the glass component further allows for discrete sensor mounting in many locations around the vehicle.

With reference to FIG. 2, the sensor-integrated glass assembly or glass assembly 100 includes a standard automotive glass component 101, an interlayer component 102, a single chip sensor 104, and a high transmission glass component 106. In various embodiments, the single chip sensor 104 is an optical sensor, such as a LiDAR sensor, having a lens integrally formed with the chip body of the sensor. In various embodiments, a heat sink 115 is thermally coupled to the single chip sensor 104. The heat sink 115 is, in some embodiments, a thermal electric cooler that provides cooling to the single chip sensor 104 as well as acting as a passthrough for vehicle interfaces such cabling connections, etc. In various embodiments, a printed circuit board 103 is electronically coupled to the single chip sensor 104 via a connection member 105.

The glass assembly 100 includes an exterior facing surface, or A-surface, 111 and an interior facing surface, or B-surface, 112. Throughout the disclosure, an exterior facing surface of each layer of the glass assembly is referred to as the A-surface and an interior facing surface of each layer of the glass assembly is referred to as the B-surface. As shown in FIG. 2, the interlayer component 102 is layered with the standard automotive glass component 101 and the high transmission glass component 106 to form a layered glass assembly 100 that satisfies automotive regulations for glass assemblies, such as safety glass regulations. In various embodiments, the interlayer component 102 is a PVB (polyvinyl butyral) component commonly used in automotive glass assemblies, in particular, windshield assemblies, to satisfy automotive glass safety regulations due to its optical clarity, adhesion to glass surfaces, toughness, and flexibility. In various embodiments, the standard automotive glass component 101 is a standard glass material used in the manufacture of a vehicle windshield in a lamination process with the interlayer component 102 and the high transmission glass component 106. In various embodiments, the high transmission glass component 106 is a glass component that permits greater accuracy passthrough of optical transmission generated and received by a sensor, such as a single chip LiDAR sensor, for example, the single chip sensor 104. In various embodiments, the high transmission glass component 106 includes one or more properties such as, for example and without limitation, high UV transparency down to around 300 nm, greater than 92% light transmittance in the visible and near IR wavelength range, low auto-fluorescence, high resistance to solarization, and a low refractive index.

In various embodiments, the single chip sensor 104 is integrated directly into the interlayer component 102. In various embodiments, the single chip sensor 104 is placed directly onto an interlayer component 102 of the glass assembly 100. In various embodiments, robotic assistance is used to precisely control the placement of the single chip sensor 104 on the interlayer component 102.

Once the single chip sensor 104 is integrated with the interlayer component 102, the high transmission glass component 106 is joined to the interlayer component 102, such as with an optical clear adhesive 122. Similarly, in various embodiments, an optical clear adhesive 123 is also used to join the standard automotive glass component 101 to the interlayer component 102 such that the interlayer component 102 is positioned between the standard automotive glass component 101 and the high transmission glass component 106. Because the single chip sensor 104 is integrally formed with the interlayer component 102, the lens of the single chip sensor 104 is closer to the A-surface 111 of the glass assembly 100, that is, the exterior facing surface of the high transmission glass component 106, reducing sensor transmission loss. This placement of the single chip sensor 104 allows optical transmissions sent and received by the single chip sensor 104 to pass through only the high transmission glass component 106, reducing sensor transmission losses. The glass assembly 100 undergoes an autoclave process, as is known in the art, to cure the adhesive and bond the components of the glass assembly 100.

In various embodiments, an intermediate layer 107 is incorporated into the glass assembly 100 between the integrated single chip sensor 104 and the interlayer component 102 and the high transmission glass component 106. The intermediate layer 107 is, in various embodiments, an antireflective coating optimized for use with LiDAR sensors, such as the single chip sensor 104. The placement of the single chip sensor 104 within the glass assembly 100 enables placement of the intermediate layer 107 on the interior-facing surface or B-surface of the high transmission glass component 106, thus reducing the amount of the antireflective coating of the intermediate layer 107 needed to cover and protect the optical transmission surface of the trim assembly 100.

With continued reference to FIG. 2, in various embodiments, the glass assembly 100 also includes a solar block filtering layer 127. In various embodiments, the solar block filtering layer 127 is interior of the single chip sensor 104 such that optical transmissions to and from the single chip sensor 104 do not need to pass through the solar block filtering layer 127. This enables solar filtering benefits, especially for windshield glass assemblies, without related sensor transmission losses. In various embodiments, the solar block filtering layer 127 is an infrared light blocking layer that reflects approximately 50% of the infrared energy to provide cooling benefits to the vehicle.

In various embodiments, the placement of the single chip sensor 104 closer to the A-surface of the glass assembly 100 enables a wider field of view while also reducing the viewing window resulting a smaller area in front of the sensor lens to be kept clean. Furthermore, the integration of the single chip sensor 104 within the glass assembly reduces the amount of material traveled through by an optical transmission to/from the single chip sensor 104, thus reducing transmission losses. In various embodiments, one or more heating elements, such as a heat element 125, is incorporated into the glass assembly 100. The heat element 125 defogs and/or defrosts the integrated single chip sensor 104 and enables heat dissipation from the single chip sensor 104.

In various embodiments, cabling and connection elements, such as connection members 135, are coupled to the single chip sensor 104 to provide power to the components and/or communication capability. In various embodiments, the connection members 135 connect the components to at least one controller of the vehicle via a wireless or wired connection. In various embodiments, a common connection member 135 is used for the single chip sensor 104 and the heat element 125 to reduce manufacturing complexity.

The embodiment illustrated in FIG. 2 is exemplary of a sensor-integrated glass assembly 100 for a vehicle windshield application. However, in other applications, fewer layers may be used to manufacture the glass assembly 100, such as use of a single layer of tinted LiDAR-compatible glass with the single chip sensor 104 mounted to the B-surface of the single glass layer using an adhesive, such as an optical clear adhesive.

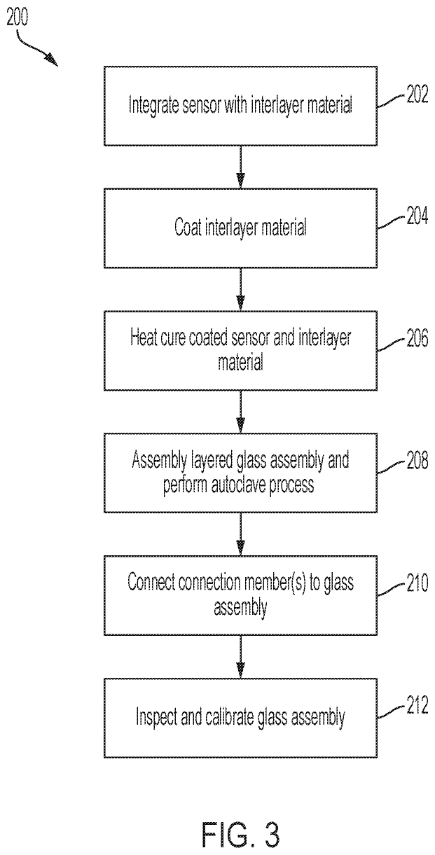

FIG. 3 illustrates a method 200 to manufacture an integrated sensor and glass assembly. The method 200 can be utilized in connection with the sensor-integrated glass assembly 100 discussed herein. The order of operation of the method 200 is not limited to the sequential execution as illustrated in FIG. 3, but may be performed in one or more varying orders, or steps may be performed simultaneously, as applicable in accordance with the present disclosure.

Beginning at 202, the single chip sensor 104 is provided and specifically placed for integration with the interlayer component 102. The specific placement tightly controls the position of the single chip sensor 104 relative to the interlayer component 102 to ensure the desired placement of the single chip sensor 104 is maintained throughout the manufacturing process.

Next, at 204, a coating is applied to the integrated single chip sensor 104 and the interlayer component 102, such as the intermediate layer 107. The intermediate layer 107 is, in various embodiments, an antireflective coating optimized for use with LiDAR sensors, such as the single chip sensor 104, and is applied on the exterior facing or A-surface of the interlayer component 102. Additionally, in some embodiments, the solar block filtering layer 127 is applied on the interior facing or B-surface of the integrated single chip sensor 104 and interlayer component 102 such that optical transmissions to and from the single chip sensor 104 do not need to pass through the solar block filtering layer 127.

The method continues with 206, as the interlayer component 102 including the integrated single chip sensor 104 is heat cured. The heat curing process includes coating the interlayer component 102 on both the interior and exterior facing surfaces with an adhesive, such as an optical clear adhesive.

Next, at 208, the interlayer component 102 is sandwiched or positioned between the standard automotive glass component 101 and the high transmission glass component 106 to form the sensor-integrated glass assembly 100. An autoclave process is performed on the glass assembly 100 to shape and finish the glass assembly 100.

The method continues at 210, wherein cabling and other electrical connection elements, such as the connection members 135 are secured to the single chip sensor 104 and/or the heating elements, such as the heat element 125 of the glass assembly 100.

Finally, at 212, inspection and calibration of the glass assembly 100 is performed to verify the desired performance of the sensor-integrated glass assembly 100.

It should be emphasized that many variations and modifications may be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fall within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives and is not intended to limit the selection to only those listed alternatives or to only one of the listed alternatives at a time, unless the context clearly indicates otherwise.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A sensor-integrated glass assembly, comprising:
a first glass component comprising an automotive glass material;
a second glass component comprising an interlayer material, the second glass component exterior to the first glass component;
a third glass component comprising a high transmission glass material, the third glass component exterior to the second glass component such that the second glass component is positioned between the first and third glass components; and
a single chip sensor having a sensor lens, the single chip sensor coupled with the second glass component;
wherein the single chip sensor is positioned on the second glass component such that a transmission from the single chip sensor passes through the third glass component and does not pass through the first glass component.

2. The sensor-integrated glass assembly of claim 1, wherein the second glass component is a PVB material.

3. The sensor-integrated glass assembly of claim 1 further comprising an intermediate layer applied to an interior facing surface of the third glass component.

4. The sensor-integrated glass assembly of claim 3, wherein the intermediate layer comprises an antireflective coating.

5. The sensor-integrated glass assembly of claim 1 further comprising a solar block filtering layer positioned interior of the single chip sensor such that the transmission from the single chip sensor does not pass through the solar block filtering layer.

6. The sensor-integrated glass assembly of claim 1, wherein the glass assembly includes a heat element to defog the sensor lens of the single chip sensor.

7. The sensor-integrated glass assembly of claim 1, wherein the glass assembly includes a heat conductive material to cool the sensor lens of the single chip sensor.

8. The sensor-integrated glass assembly of claim 1 further comprising a heat sink thermally coupled to the single chip sensor.

9. The sensor-integrated glass assembly of claim 1 further comprising a connection member coupled to the single chip sensor and positioned interior of the single chip sensor to provide power and communication to the single chip sensor.

10. A method for manufacturing a sensor-integrated glass assembly for a vehicle sensor, comprising:
providing a single chip sensor including a sensor lens;
providing a first glass component, a second glass component, and a third glass component;
integrating the single chip sensor with the second glass component;
adhering, with an optical clear adhesive, the first glass component to an interior facing surface of the second glass component and the third glass component to an exterior facing surface of the second glass component such that the second glass component is positioned between the first and third glass components and the sensor lens is positioned to transmit and receive optical transmission through the third glass component;
applying an antireflective coating to the third glass component; and
connecting a connection member to the single chip sensor.

11. The method of claim 10 further comprising curing the sensor-integrated glass assembly in an autoclave process.

12. The method of claim 10 further comprising applying a solar block filtering layer to the first glass component.

13. An automotive vehicle comprising a vehicle body including a sensor-integrated glass assembly, the sensor-integrated glass assembly including a first glass component comprising an automotive glass material; a second glass component comprising an interlayer material, the second glass component exterior to the first glass component; a third glass component comprising a high transmission glass material, the third glass component exterior to the second glass component such that the second glass component is positioned between the first and third glass components; and a single chip sensor having a sensor lens, the single chip sensor coupled with the second glass component, wherein the single chip sensor is positioned on the second glass component such that a transmission from the single chip sensor passes through the third glass component and does not pass through the first glass component.

14. The automotive vehicle of claim 13, wherein the second glass component is a PVB material.

15. The automotive vehicle of claim 13, wherein the sensor-integrated glass assembly further comprises an intermediate layer applied to an interior facing surface of the third glass component.

16. The automotive vehicle of claim 15, wherein the intermediate layer comprises an antireflective coating.

17. The automotive vehicle of claim 13, wherein the sensor-integrated glass assembly includes a heat element to defog the sensor lens of the single chip sensor.

18. The automotive vehicle of claim 13, wherein the sensor-integrated glass assembly includes a heat conductive material to cool the sensor lens of the single chip sensor.

19. The automotive vehicle of claim 13 further comprising a heat sink thermally coupled to the single chip sensor.

20. The automotive vehicle of claim 13, wherein the sensor-integrated glass assembly includes a solar block filtering layer positioned interior of the single chip sensor such that the transmission from the single chip sensor does not pass through the solar block filtering layer.
